(19) United States
(12) Patent Application Publication
(10) Pub. No.: US 2026/0322039 A1
(43) Pub. Date: Oct. 15, 2026

(54) Plug Connector Part with Electrically Connectable Shields

(71) Applicant: Phoenix Contact GmbH & Co. KG, Blomberg (DE)

(72) Inventors: Thomas Kaps, Vlotho (DE); Karsten Krome, Detmold (DE); Sebastian Stamm, Brakel (DE); Jürgen Sahm, Ammerbuch (DE); Tim Kindermann, Oerlinghausen (DE)

(21) Appl. No.: 19/476,288

(22) PCT Filed: Apr. 17, 2024
(86) PCT No.: PCT/EP2024/060344

§ 371 Date: Oct. 17, 2025

(30) Foreign Application Priority Data
Apr. 28, 2023 (BE) BE2023/05338

(51) Int. Cl. H01R 13/6581; H01R 12/71; H01R 13/6597

(52) U.S. Cl. CPC H01R 13/6581; H01R 12/716; H01R 13/6597

(57) ABSTRACT

A plug connector part for connection to a mating plug connector part comprises: Data lines, an inner shield surrounding the data lines, lines arranged outside the inner shield and an outer shield which surrounds the data lines, the inner shield and the lines, with the inner shield and the outer shield each having a terminal contact section for electrical contact with a respective mating contact and with the inner shield and the outer shield being electrically separated from one another and being electrically connectable to one another via the terminal contact sections.

The invention relates to a plug connector part for connection to a mating plug connector part, a terminal arrangement with such a plug connector part and a method for producing a terminal arrangement.

Plug connector parts that carry both data lines and load lines are sometimes also referred to as hybrid plug connector parts. Such plug connector parts enable single-cable solutions and therefore compact devices through functional integration of contacts for electrical/optical power, signal and data transmission within a plug connection.

In an exemplary embodiment of a circular plug connector part, a hybrid device plug connector part has a housing screw connection for connection to a corresponding mating plug connector part. In practical designs, the housing screw connection can be made of a conductive material and thus provide an outer EMC shield. As usual, the abbreviation EMC stands for “electromagnetic compatibility” and refers to the ability of a technical device not to disturb other devices through unwanted electrical or electromagnetic effects or, conversely, to be disturbed by other devices.

The outer EMC shield thus protects the plug connector part from external electromagnetic coupling or radiation and, conversely, external systems from interference from the plug connector part. As sensitive data signals are typically transmitted within a hybrid plug connector part, an additional “inner” EMC shield is regularly provided. The inner EMC shield protects the respective data lines from electromagnetic interference from the load lines within the plug connector part, which can also be referred to as power contacts. The inner EMC shield and the outer EMC shield can be electrically connected to one another or, alternatively, galvanically separated from one another.

For example, the standards IEC 63171-7 (“SPE M12 Hybrid”) and IEC 61076-2-117 (“M12-M40 Hybrid”) describe hybrid plug connector parts.

In general, there is growing interest in hybrid interfaces. One challenge here is the increasing number of different variants of plug connector parts and the resulting relatively complex production process.

The object of the present invention is to simplify the production of plug connector parts.

This object is achieved by a subject matter having the features of claim 1.

Accordingly, a plug connector part for connection to a suitable mating plug connector part comprises a plurality of data lines, an inner shield surrounding the data lines on the outside, a plurality of lines arranged outside the inner shield and an outer shield which surrounds the data lines, the inner shield and the lines on the outside. It is provided that the inner shield and the outer shield each have a terminal contact section for electrical contact with a respective mating contact, with the inner shield and the outer shield being electrically separated from one another and being electrically connectable to one another via the terminal contact sections.

This is based on the knowledge that some users of plug connector parts of this kind require an electrical connection between the outer and inner shield, while other users want to keep the two shields galvanically separated from one another. This is because the relevant standards (IEC 63171-6, IEC 63171-7, IEC 61076-2-113 and IEC 61076-2-117) do not specify whether the inner shield and the outer shield should be electrically connected or galvanically separated from one another. This presents manufacturers of plug connector parts with the decision to offer a hybrid plug connector part with separated or connected shields or to provide different article variants. The proposed plug connector part solves this problem in that the decision on the electrical connection of the two shields can be made by the users themselves, namely by the user electrically connecting the terminal contact sections of the two shields to one another or not. The terminal contact elements can, for example, be connected to corresponding terminals on a printed circuit board, e.g. using THR, SMD or wave soldering methods or press-fit technology. With the design of the printed circuit board layout, the user can define the wiring of the printed circuit board terminals and thus the shield concept of the hybrid plug connector part. The inner shield and the outer shield each represent in particular an EMC shield, as described above.

In this way, a variable shield concept can be created for hybrid plug connector parts, in particular device plug connector parts, which, depending on the configuration, enables either an electrical connection or galvanic separation of the potentials of the inner and outer shield. This concept therefore enables a reduced article variance. A reduced article variance initially allows the manufacturer of the plug connector parts to benefit from cost and time advantages in the development process. Furthermore, expenses in procurement, assembly, quality assurance, warehousing and mapping of articles in IT systems can be reduced. At the same time, the flexibility of a variable solution increases the benefits for users. Furthermore, the risk of confusion between articles with connected shield potentials and those with separated shield potentials can be reduced.

The plug connector part is designed in accordance with the IEC 63171-6, IEC 63171-7, IEC 61076-2-113 or IEC 61076-2-117 standard, for example. The lines arranged outside the inner shield are in particular electrical lines, e.g. signal lines and/or power lines, in particular load lines for carrying a load current.

The inner shield can be electrically insulated from the outer shield by an outer insulating body inside the outer shield. This enables secure insulation and stable support at the same time.

The terminal contact section of the inner shield and/or the terminal contact section of the outer shield is/are (in each case) in the form of a pin, for example. This enables particularly simple electrical contacting, for example on a printed circuit board.

The terminal contact section of the inner shield and the terminal contact section of the outer shield can be aligned parallel to one another. This allows the two terminal contact sections to be electrically connected to a printed circuit board in one step, for example.

The terminal contact section of the inner shield and/or the terminal contact section of the outer shield and/or terminal contact sections of the data lines and/or terminal contact sections of the (outer) lines can be inserted into holes in a printed circuit board. This allows the plug connector part to be simply plugged onto a printed circuit board in one step.

The outer shield can form a housing screw connection. The outer shield can have at least one thread. This enables secure fastening to a housing and/or with a mating plug connector part.

The terminal contact section of the outer shield can be formed on a contact spring. The contact spring is optionally spring-elastically pre-loaded against a base body of the outer shield. This makes it easy to produce the base body and at the same time ensures reliable electrical contact with the terminal contact section.

According to one aspect, there is provided a terminal arrangement comprising the plug connector part according to any configuration described herein and a printed circuit board. With regard to the advantages, reference is made to the above statements on the plug connector part.

The mating contact for the terminal contact section of the inner shield and the mating contact for the terminal contact section of the outer shield can be electrically separated from one another. The inner shield is galvanically separated from the outer shield and the plug connector part is suitable for applications in which such separation is required.

The mating contact for the terminal contact section of the inner shield and the mating contact for the terminal contact section of the outer shield can be electrically connectable or connected to mutually different earth or reference potentials. This ensures an effective EMC shield.

Alternatively, the mating contact for the terminal contact section of the inner shield and the mating contact for the terminal contact section of the outer shield can be electrically connected to one another. The plug connector part is then suitable for applications in which an electrical connection of the two potentials is predefined.

Optionally, the mating contact for the terminal contact section of the inner shield and the mating contact for the terminal contact section of the outer shield are electrically connected to one another and/or in operative connection via at least one electrical or electronic component. This opens up completely new application possibilities, such as monitoring the shields and/or selective electrical connection of the two shields.

The at least one component can comprise a resistor, an inductor, a capacitor, a diode and/or a varistor. A network of such and/or other components is optionally provided. This allows a complex analysis of the shield potentials and a targeted influencing of the properties of the shield system is also possible.

The mating contact for the terminal contact section of the inner shield and the mating contact for the terminal contact section of the outer shield can be formed on mutually different printed circuit board layers of the printed circuit board. This allows the shield potentials to be routed separately from one another.

According to one aspect, a method for producing a terminal arrangement, in particular according to any configuration described herein, is indicated. The method comprises the following steps: Producing or selecting a printed circuit board having mating contacts, and electrically contacting the terminal contact sections of a plug connector part according to any configuration described herein with the mating contacts of the printed circuit board. It is provided that the printed circuit board is produced or selected in such manner that the mating contacts for the terminal contact section of the inner shield and for the terminal contact section of the outer shield are or become either electrically separated from one another or electrically connected to one another. With regard to the advantages, reference is made to the above statements on the plug connector part.

The idea underlying the invention will be explained in more detail below on the basis of the exemplary embodiments represented in the figures, for which is shown:

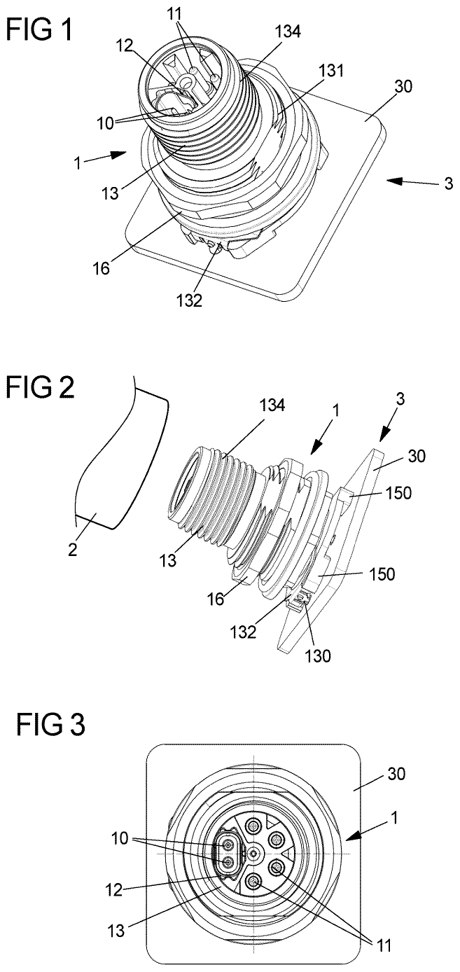

FIG. 1 a view of a plug connector part for connection to a mating plug connector part with a printed circuit board;

FIG. 2 a view of the plug connector part according to FIG. 1 and a suitable mating plug connector part;

FIG. 3 a top view of the plug face of the plug connector part according to FIG. 1;

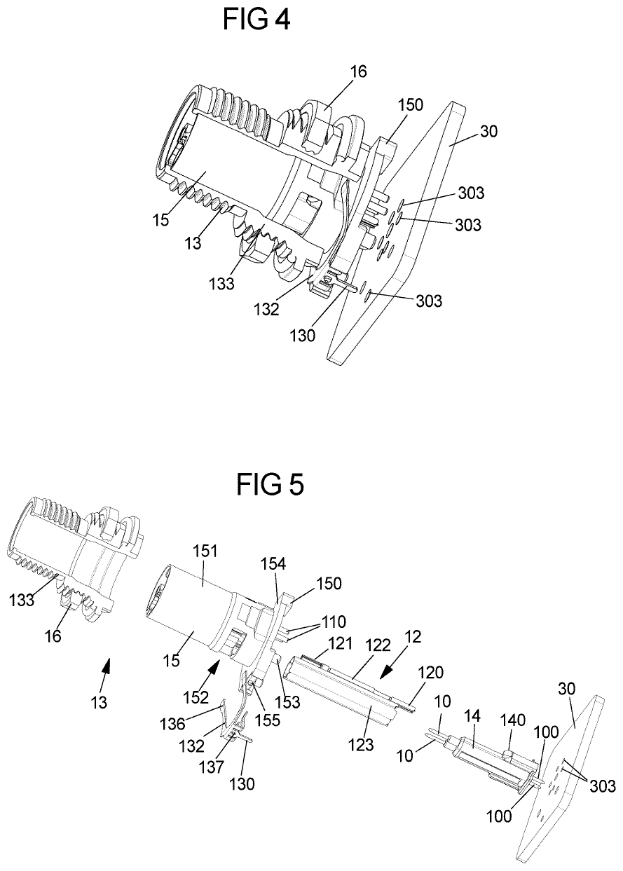

FIG. 4 a partially cut-away view of the plug connector part according to FIG. 1 together with the printed circuit board;

FIG. 5 an exploded view of the plug connector part according to FIG. 1 together with the printed circuit board;

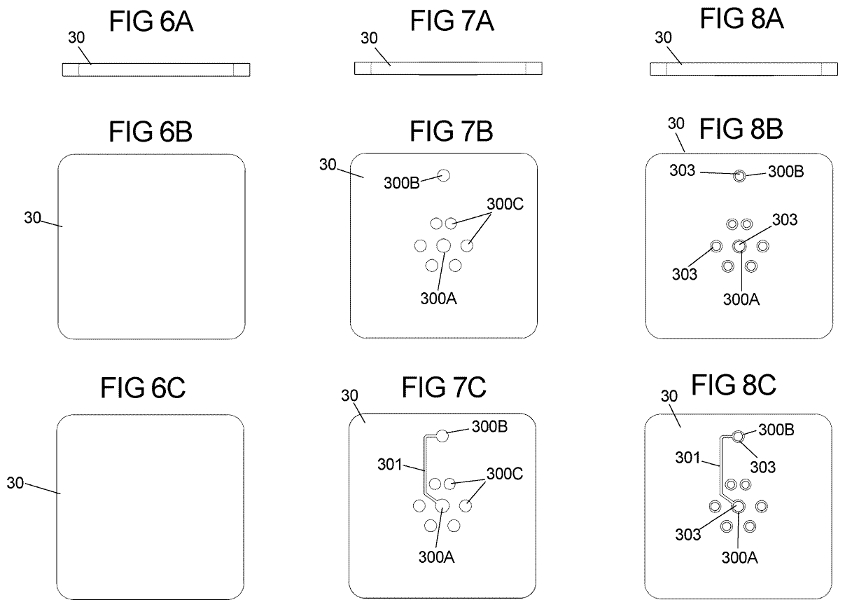

FIGS. 6A to 12C different stages in the production of a terminal arrangement with the plug connector part according to FIG. 1 and the printed circuit board;

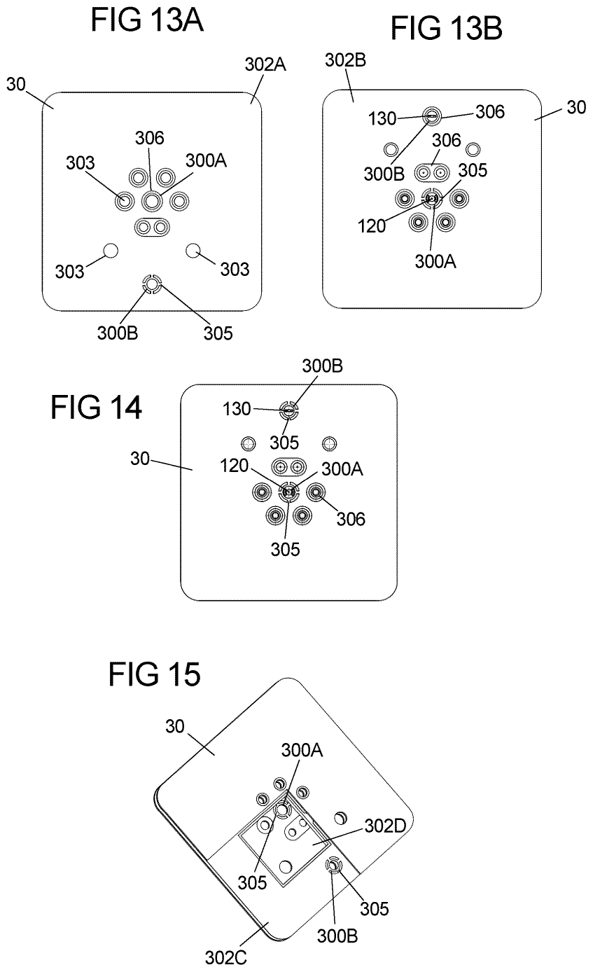

FIG. 13A to 18 different configurations of the printed circuit board; and

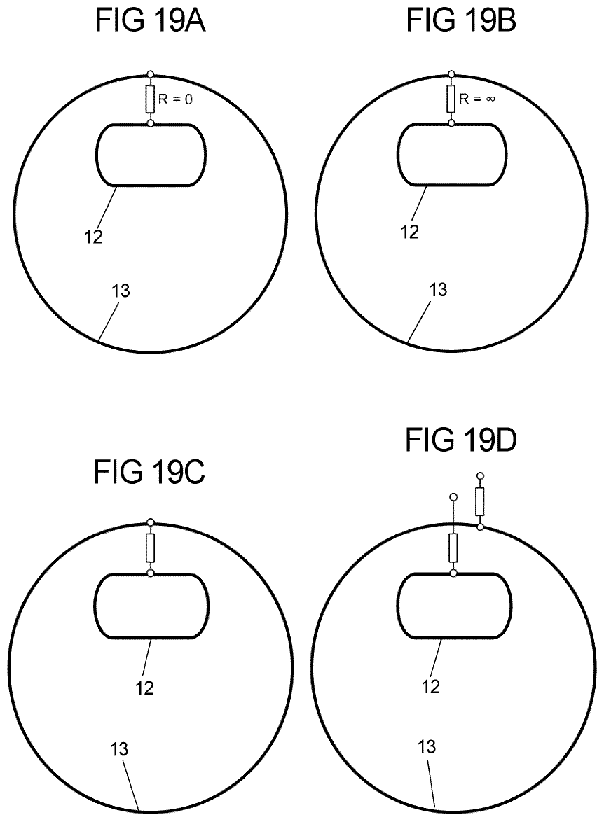

FIG. 19A to 19D circuit diagrams for different configurations of the printed circuit board.

FIGS. 1 to 5, to which reference is made jointly, show a plug connector part 1 for connection to a mating plug connector part 2. In the present case, the plug connector part 1 is designed by way of example as a circular plug connector part, specifically as a hybrid device plug connector part. Furthermore, an exemplary printed circuit board 30 is shown, which together with the plug connector part 1 forms a terminal arrangement 3. In the assembled state, the plug connector part 1 rests on the printed circuit board 30 and is electrically connected thereto.

The plug connector part 1 comprises a plurality of, in this case two, (electrical) data lines 10 and an inner shield 12 surrounding the data lines 10. The data lines 10 can also be referred to as data contacts. The inner shield 12 has a base body 123 in which the data lines 10 are arranged. The base body 123 is sleeve-shaped. The inner shield 12 is produced from an electrically conductive material, in this case a metal such as aluminium or brass. The inner shield 12 provides an EMC shield for the data lines 10. The inner shield 12 is in the form of a shield plate.

Furthermore, the plug connector part 1 comprises lines which are arranged outside the inner shield 12 and which are represented here as load lines 11 by way of example (with the lines 11 alternatively or additionally also being able to comprise further data lines, signal lines or generally power lines), and an outer shield 13. In the example shown, the load lines 11 have a larger cross-section than the data lines 10. The load lines 11 are used to transmit load currents, e.g. to supply power to a device with the plug connector part 1 or to supply power through a device with the plug connector part 1. The outer shield 13 surrounds the data lines 10, the inner shield 12 and the load lines 11. The outer shield 13 has an interior in which the inner shield 12 with the data lines 10 arranged therein and, next to it, the load lines 11 are arranged. The outer shield 13 provides an EMC shield for the data lines 10 and the load lines 11.

The outer shield 13 is produced from an electrically conductive material, in this case a metal such as aluminium or brass. The outer shield 13 has a thread 131 for a nut 16. In this case, the outer shield 13 forms a housing screw connection. By means of the nut 16 screwed onto the thread 131, the plug connector part 1 can be screwed to the wall in an opening of a wall. The outer shield 13 also has a base body 133, on which (together with the thread 131 for the nut 16) a thread 134 is formed for a suitable mating thread of the mating plug connector part 2. The base body 133 thus serves both as the outer EMC shield and for the housing screw connection and screw connection to the mating plug connector part 2.

Contacts for a protective earth “PE”, a functional earth “FE”, shield contacts and additional signal contacts can also be integrated.

Furthermore, the plug connector part 1 comprises an inner insulating body 14. As can be seen in particular on the basis of FIG. 5, the data lines 10 are held by the inner insulating body 14. The inner insulating body 14 encloses the data lines 10. Here, plug contact ends of the data lines 10 protrude from the inner insulating body 14 on one side for plug-in connection with corresponding mating plug contacts of the mating plug connector 2. On the opposite side of the inner insulating body 14, terminal contact sections 100 of the data lines 10 protrude from the inner insulating body 14. The terminal contact sections 100 of the data lines 10 are used for insertion into holes 303 of the printed circuit board 30. Furthermore, the inner insulating body 14 has latching elements 140, by means of which the inner insulating body 14 is latched with corresponding latching elements 152 of an outer insulating body 15 in the assembled state. A form-fitting connection secures the position. For this purpose, the inner insulating body 14 has specifically at least one latching hook that locks in an undercut of the outer insulating body 15 during assembly. The inner insulating body 14 electrically insulates the data lines 10 from the inner shield 12.

The plug connector part 1 also comprises the outer insulating body 15. The outer insulating body 15 carries the load lines 11 and the inner shield 12 together with the inner insulating body 14 and data lines 10. The outer insulating body 15 has a cylinder section 151, in and along which run the load lines 11 and the inner shield 12 together with the inner insulating body 14 and data lines 10. The outer insulating body 15 and the base body 133 do not latch together in the example shown. These parts are not fastened to one another by the plug connector design. The outer insulating body 15 is firmly connected to the printed circuit board 30 via the terminal contact sections 100. The printed circuit board 30 is fastened in a device, e.g. using screws or clamps. This secures the position of the outer insulating body 15 in relation to the base body 133, which is also fastened to the device. This means that no force is required during assembly that could cause the printed circuit board to bend, and the housing can be easily opened without loosening the latches. The outer insulating body 15 has feet 150 with which the plug connector 1 is in contact with the printed circuit board in the assembled state. Positioning pins 153 are designed to be inserted into holes 303 in the printed circuit board 30 in order to ensure correct positioning. The outer insulating body 15 electrically insulates the inner shield 12 inside the outer shield 13 from the outer shield 13. On one side, plug contact ends of the load lines 11 are accessible for plug-in connection with corresponding mating plug contacts of the mating plug connector 2 in the outer insulating body 15. On the opposite side of the outer insulating body 15, terminal contact sections 110 of the load lines 11 protrude from the outer insulating body 15. The terminal contact sections 110 of the load lines 11 are used for insertion into corresponding holes 303 of the printed circuit board 30.

The data lines 10, the inner insulating body 14 and the inner shield 12 form a pre-assembled sub-assembly. During assembly, the sub-assembly is inserted into the outer insulating body 15 with the load lines 11.

The plug connector part 1 is optionally designed in accordance with one of the standards IEC 63171-6, IEC 63171-7, IEC 61076-2-113 or IEC 61076-2-117.

The inner shield 12 and the outer shield 13 each have a terminal contact section 120, 130 for electrical contact with a respective mating contact 300A, 300B, which is explained in more detail below. The inner shield 12 and the outer shield 13 are electrically separated from one another. The inner shield 12 and the outer shield 13 are electrically connectable to one another via the terminal contact sections 120, 130. The terminal contact sections 120, 130 are spaced apart from one another.

In the example shown, the terminal contact section 120 of the inner shield 12 is formed by a shield line 121, which runs in a receptacle 122 of the inner shield 12. The shield line 121 can be electrically contacted by a shield line of the mating plug connector 2.

The terminal contact section 130 of the outer shield 13 is formed on a contact spring 132. The contact spring 132 is spring-elastically pre-loaded against the base body 133 of the outer shield 13. The contact spring 132 has a plurality of spring arms 136. The contact spring 132 is pre-loaded against the base body 133 of the outer shield 13. In the present case, the contact spring 132 is supported on a shoulder 154 of the outer insulating body 15. In the example shown, the shoulder 154 adjoins one end of the cylinder section 151 of the outer insulating body 15.

The contact spring 132 is pushed laterally onto the outer insulating body 15. The contact spring 132 also has an opening 137. In the assembled state, the opening 137 is plugged onto a positioning pin 155 of the outer insulating body 15. The positioning pin 155 is aligned perpendicular to the direction in which the spring arms 136 press against the base body 133 of the outer insulating body 13.

The terminal contact section 120 of the inner shield 12 and the terminal contact section 130 of the outer shield 13 are each in the form of a pin. The terminal contact section 120 of the inner shield 12 and the terminal contact section 130 of the outer shield 13 are aligned parallel to one another. The terminal contact section 120 of the inner shield 12 and the terminal contact section 130 of the outer shield 13 can each be inserted into a hole 303 of the printed circuit board 30.

This means that a potential electrical connection point between the inner and outer shield 12, 13 is not implemented within the plug connector part 1, but rather outside the plug connector part 1 and is transferred to the printed circuit board layout of the respective application. For this purpose, the inner and outer shield 12, 13 are galvanically separated from one another as described. Both shield potentials are led out of the plug connector part 1 separately, each with at least one terminal contact section 120, 130. The plug connector part 1 can also be referred to as a printed circuit board plug connector part.

The user defines whether or not the inner shield 12, 13 is electrically connected to the outer shield 12, 13 by the respective wiring of the printed circuit board terminals.

With reference to FIGS. 6A to 12C, steps for an exemplary production of the terminal arrangement 3 will now be described below. In each case, a side view is shown at the top (e.g. FIGS. 6A and 7A), a top view is shown in the centre in a case in which the inner and outer shields 12, 13 in the terminal arrangement are electrically insulated from one another (e.g. FIGS. 7B and 8B), and a top view is shown at the bottom in a case in which the inner and outer shields 12, 13 in the terminal arrangement are electrically connected to one another (e.g. FIGS. 7C and 8C).

Firstly, a printed circuit board layout is developed for an application, usually using printed circuit board design software. This defines the details of the printed circuit board and therefore also the wiring of the printed circuit board terminals. This step therefore determines whether the inner and outer shield 12, 13 are connected. A printed circuit board design file is transferred in particular to a printed circuit board manufacturer in a common format (e.g. as a Gerber file or as a Zuken archive). A printed circuit board material is then selected. This is, for example, an insulating printed circuit board base material (e.g. FR4) to which conductive coatings (e.g. copper foils) have already been applied (on one or both sides). This is shown in FIG. 6A-6C.

The next step is to produce the conductor pattern. Conductor and pad geometries are removed from the conductive coating using an ablative process (e.g. etching, milling or lasering). This creates the mating contacts 300A, 300B, 300C for the terminal contact sections 100, 110, 120, 130 of the data lines, the load lines, the inner shield 12 and the outer shield 13. Furthermore, this creates an electrical connection line 301 between the mating contacts 300A, 300B of the inner and outer shield 12, 13, if this is required in the design file. From a cost point of view, the connection made in this way is neutral because no additional costs are incurred by removing or not removing the connection on the printed circuit board 30. For printed circuit boards with conductive inner layers, these work steps are carried out for each inner layer. The individual printed circuit board layers are then stacked and pressed together to form a printed circuit board. FIGS. 7A-7C show the printed circuit board 30 after production of the conductor pattern.

The next step involves drilling and optionally galvanising. Here, holes 303 are produced, for example, for the terminal contact sections 100, 110, 120, 130 and positioning pins 153 of the plug connector part 1. Conductive connections between conductors at different printed circuit board layers, known as through-hole plating, are created in an optional downstream galvanic or chemical deposition process. Solder resist masks and/or printing are then optionally applied. Further process steps can follow to produce the printed circuit board contours. These are usually separating processes such as milling, sawing or scoring. FIGS. 8A-8C show the printed circuit board 30 after the holes have been produced.

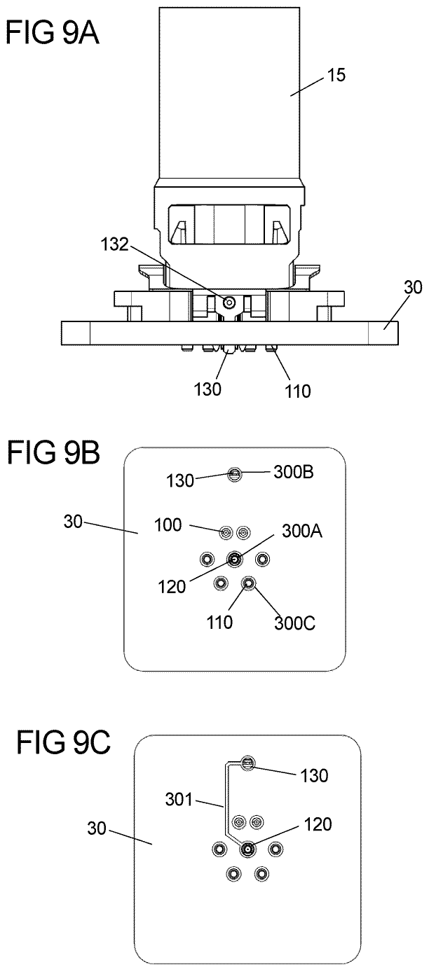

In a subsequent step, the printed circuit board is assembled. The plug connector part 1 (optionally as shown except for the housing screw connection from the base body 133 of the outer shield 13 and the nut 16) is fitted manually or automatically. For automatic assembly, a suction cap can be provided on the plug connector part 1 to position the product with a vacuum gripper. The connection between the terminal contact sections 120, 130 of the inner and outer shield 12, 13 of the plug connector part 1 and the mating contacts 300A, 300B can be implemented as press-fit technology. In this case, the printed circuit board 30 is then fully assembled. If the connection is to be produced using SMD or THR reflow soldering methods, for example, a solder paste is applied to the printed circuit board terminals before the printed circuit board is assembled. FIGS. 9A-9C show the printed circuit board 30 fitted with the aforementioned parts of the plug connector part 1.

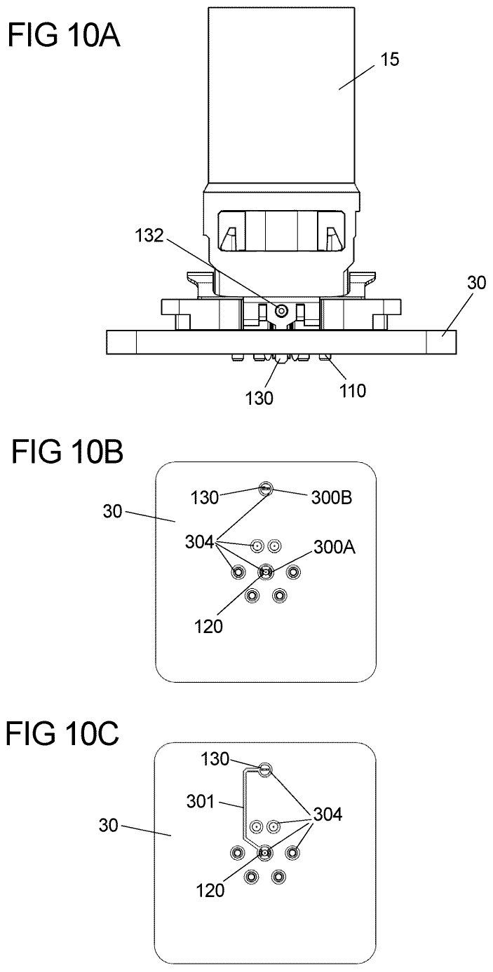

In a further step, the terminal contact sections 100, 110, 120, 130 of the plug connector part 1 are soldered, e.g. using SMD, THR, wave or hand soldering methods. After this work step (or after the previous step in the case of press-fit technology), the terminal contact sections 120, 130 of the inner and outer shield 12, 13 are connected to the mating contacts 300A, 300B of the printed circuit board 30 in a materially-bonded manner (in a force-fitting manner in the case of press-fit technology). FIGS. 10A-10C show the plug connector part 1 soldered at soldering points 304 (in the example shown, except for the housing screw connection consisting of the base body 133, the outer shield 13 and the nut 16). The contact spring 132 of the outer shield 13 is already mounted on the outer insulating body 15.

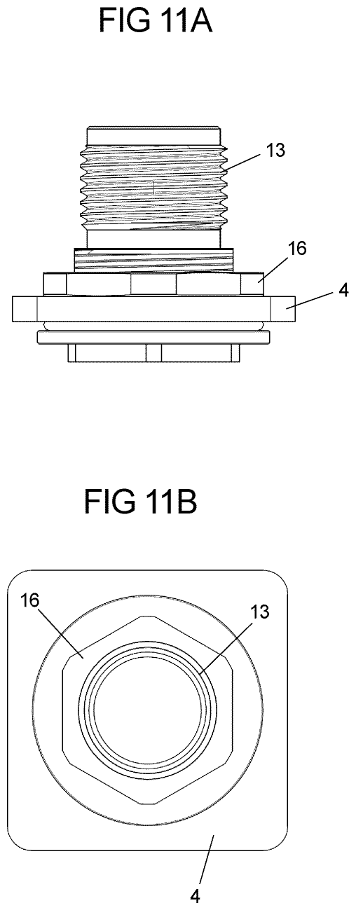

The base body 133 of the outer shield 13 is then (or already at an earlier stage) mounted in a panel or a switch cabinet wall or another housing wall 4 and screwed thereto by means of the nut 16, see FIGS. 11A and 11B.

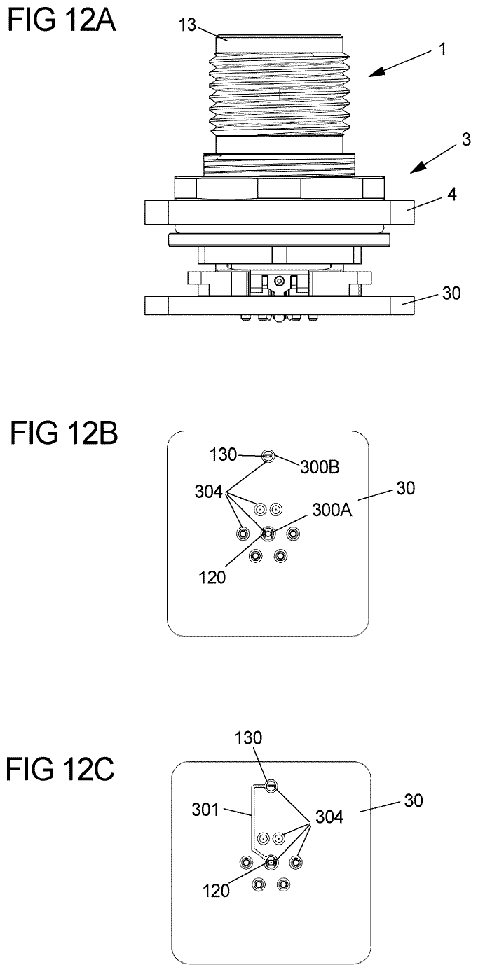

Lastly, the assembled and soldered printed circuit board 30 is installed in a device, see FIG. 12A-12C. In this step, the inner components of the hybrid plug connector part 1 are joined to the housing screw connection. The contact spring electrically connects the housing screw connection with the corresponding terminal contact section 130. Depending on the configuration of the printed circuit board layout, there is now an electrical connection between the inner and outer shield 12, 13, or the shield potentials are separate or connected differently (see below).

According to FIG. 12B, the mating contact 300A for the terminal contact section 120 of the inner shield 12 and the mating contact 300B for the terminal contact section 130 of the outer shield 13 are electrically separated from one another.

According to FIG. 12C, the mating contact 300A for the terminal contact section 120 of the inner shield 12 and the mating contact 300B for the terminal contact section 130 of the outer shield 13 are electrically connected to one another via the connection line 301 of the printed circuit board 30.

In general, the following steps can be provided in a method for producing the terminal arrangement 3: (a) producing or selecting the printed circuit board 30 with mating contacts 300A-300C and (b) electrically contacting the terminal contact portions 100, 110, 120, 130 of the plug connector part 1 with the mating contacts 300A-300C of the printed circuit board 30, with the printed circuit board 30 being produced or selected in such manner that the mating contacts 300A, 300B for the terminal contact section 120 of the inner shield 12 and for the terminal contact section 130 of the outer shield 13 are optionally electrically separated from one another or electrically connected to one another.

Various possibilities are conceivable for the specific configuration of the printed circuit board 30, with a plurality of examples being described below.

In the alternative according to FIG. 12B, the terminal contact sections 120, 130 of the inner and outer shield 12, 13 of the plug connector part 1 are only connected to the printed circuit board terminals for mechanical reasons and are electrically insulated from one another. FIG. 19B shows a corresponding circuit diagram.

In the alternative according to FIGS. 13A and 13B, the printed circuit board 30 has an upper side with a conductive printed circuit board layer 302A (FIG. 13A) and an underside with a conductive printed circuit board layer 302B (FIG. 13B). The mating contacts 300A, 300B (in the form of printed circuit board terminals) of the inner and outer shield 12, 13 are electrically connected to the different outer printed circuit board layers 302A, 302B. In the example represented, the central printed circuit board terminal, the mating contact 300A of the inner shield 12, is electrically connected on the underside to the so-called bottom layer as an outer conductive printed circuit board layer 302B of the printed circuit board 30 by means of a contact 305. The mating contact 300B of the outer shield 13 is electrically insulated from this printed circuit board layer 302B by an insulation 306. The printed circuit board terminal with the mating contact 300A of the outer shield 13 is electrically connected to the top layer as a further outer printed circuit board layer 302A by means of a contact 305. The mating contact 300A of the inner shield 12 is electrically insulated from this printed circuit board layer 302A by an insulation 306. The top and bottom layers are galvanically separated from one another. For example, different earth or reference potentials can be implemented for the inner and outer shield 12, 13.

FIG. 14 shows a further example with electrically connected mating contacts 300A, 300B of the inner and outer shield 12, 13 according to the circuit diagram of FIG. 19A. The mating contacts 300A, 300B are electrically connected to the same earth or reference potential. For this purpose, both mating contacts 300A, 300B are connected via contacts 305 in the same electrically conductive printed circuit board layer. An alternative embodiment is shown in FIGS. 13A, 13B and 15, where the earth or reference potentials are electrically connected to one another within the printed circuit board 30.

According to FIG. 15, the terminal contact sections 120, 130 of the inner and outer shield 12, 13 are connected to different inner printed circuit board layers 302C, 302D. In the example represented, the central mating contact 300A of the inner shield 12 is connected to a first inner conductive printed circuit board layer 302D and the mating contact 300B of the outer shield 13 to a second inner conductive printed circuit board layer 302C. The printed circuit board layers 302C, 302D are galvanically separated from one another. The embodiments according to FIGS. 13A and 13B and FIG. 15 can be combined as desired. For example, another embodiment could be realised by connecting the inner and outer shields 12, 13 in an outer and an inner printed circuit board layer.

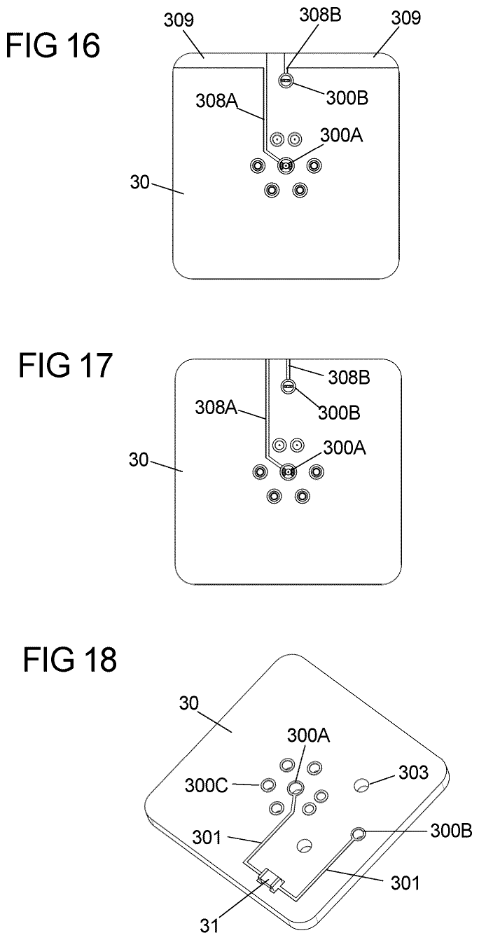

According to FIG. 16, the mating contacts 300A, 300B are each connected via a connection line 308A, 308B to different fields 309 and thus to earth or reference potentials on the same printed circuit board layer.

According to FIG. 17, the mating contacts 300A, 300B are each connected via a connection line 308A, 308B to different earth or reference terminals, which lead, for example, to other printed circuit board levels or other system components.

According to FIG. 18, the mating contact 300A for the terminal contact section 120 of the inner shield 12 and the mating contact 300B for the terminal contact section 130 of the outer shield 13 are electrically connected to one another via (at least) one electrical or electronic component 31. The use of at least one electrical or electronic component 31 between the shield potentials is envisaged here. For this purpose, an interrupted connection point is provided in a connection line 301 between the mating contacts 300A, 300B of the inner and outer shield 12, 13. The interruption is fitted with at least one or a plurality of (series and/or parallel connection, SMD and/or THR) component(s) 31. Alternatively, the connection can also be implemented between the mating contacts 300A, 300B and the earth or reference levels of a printed circuit board. This arrangement allows, for example, the installation of defined resistors, inductors or capacitors as well as networks of these components. An arrangement of this kind can be used, for example, to optimise the unbalanced attenuation if the inner shield is terminated with the common-mode impedance of the data line(s) 10 against the outer shield or a ground plane. Furthermore, the data lines 10 can be terminated with their push-pull impedance against the inner and/or outer shield 12, 13, e.g. to terminate a transmission line. This use case is particularly interesting for multidrop applications.

Furthermore, low-pass, band-pass or high-pass filters as well as resonant circuits between the shield potentials can be provided. These can couple or separate the shield potentials in certain operating states. Further embodiments result from the use of one or a plurality of diodes or one or a plurality of varistors, which allow coupling only in one direction or in the event of a fault. From this point of view, interference could be diverted from the inner shield 12 to the outer shield 13, but no external interference could reach the inner shield 12 of the data lines 10.

If necessary, the connection point can be fitted with measurement technology or optical or acoustic components. These components can be used specifically for fault indication to warn of dangerous conditions or to switch off the power supply in the hybrid connection. One or a plurality of fuses or one or a plurality of switches can be provided as component(s). In this context, the combination of a hybrid plug connector part 1 and the terminal for a residual current circuit breaker (as a component) could be particularly interesting in order to switch off a system in the event of dangerous currents on the touchable shield potentials. The use of switches can be used specifically to interrupt the potentials in certain operating situations (e.g. starting up a system, starting motors, welding processes, etc.).

FIGS. 19C and 19D show possible circuit diagrams for the use of one or a plurality of the components 31 described. The at least one component 31 can be connected between the inner and outer shield 12, 13 or the inner and outer shield 12, 13 can each be connected to further components via at least one component 31.

The idea underlying the invention is not limited to the exemplary embodiments described above, but can in principle also be implemented in a completely different way.

### LIST OF REFERENCE NUMERALS

1 Plug connector part
10 Data line
100 Terminal contact section
11 Load line
110 Terminal contact section
12 Inner shield
120 Terminal contact section
121 Shield line
122 Receptacle
123 Base body
13 Outer shield
130 Terminal contact section
131 Thread
132 Contact spring
133 Base body
134 Thread
136 Spring arm
137 Opening
14 Inner insulating body
140 Latching element
15 Outer insulating body
150 Foot
151 Cylinder section
152 Latching element
153 Positioning pin
154 Shoulder
155 Positioning pin
16 Nut
2 Mating plug connector part
3 Terminal arrangement
30 Printed circuit board
300A-300C Mating contact
301 Connection cable
302A-302D Printed circuit board layer
303 Hole
304 Soldering point
305 Contact
306 Insulation
308A, 308B Connection cable
309 Field
31 Component
4 Housing wall

1. A plug connector part for connection to a mating plug connector part, comprising:
data lines,
an inner shield surrounding the data lines,
lines arranged outside the inner shield and
an outer shield which surrounds the data lines, the inner shield and the lines,
wherein the inner shield and the outer shield each have a terminal contact section for electrical contact with a respective mating contact and wherein the inner shield and the outer shield are electrically separated from one another and are electrically connectable to one another via the terminal contact sections.

2. The plug connector part according to claim 1, wherein the inner shield is electrically insulated from the outer shield by an outer insulating body inside the outer shield.

3. The plug connector part according to claim 2, wherein the terminal contact section of the inner shield and the terminal contact section of the outer shield are in the form of a pin.

4. The plug connector part according to claim 2, wherein the terminal contact section of the inner shield and the terminal contact section of the outer shield are aligned parallel to one another.

5. The plug connector part according to claim 1, wherein the terminal contact section of the inner shield, theterminal contact section of the outer shield, terminal contact sections of the data lines and terminal contact sections of the lines can be inserted into holes of a printed circuit board.

6. The plug connector part according to claim 1, wherein the outer shield forms a housing screw connection and has at least one thread.

7. The plug connector part according to claim 1, wherein the terminal contact section of the outer shield is formed on a contact spring, wherein the contact spring is spring-elastically pre-loaded against a base body of the outer shield.

8. A terminal arrangement, comprising the plug connector part according to claim 1 and a printed circuit board.

9. The terminal arrangement according to claim 8, wherein the mating contact for the terminal contact section of the inner shield and the mating contact for the terminal contact section of the outer shield are electrically separated from one another.

10. The terminal arrangement according to claim 9, wherein the mating contact for the terminal contact section of the inner shield and the mating contact for the terminal contact section of the outer shield are electrically connected to mutually different reference potentials.

11. The terminal arrangement according to claim 8, wherein the mating contact for the terminal contact section of the inner shield and the mating contact for the terminal contact section of the outer shield are electrically connected to one another.

12. The terminal arrangement according to claim 11, wherein the mating contact for the terminal contact section of the inner shield and the mating contact for the terminal contact section of the outer shield are electrically connected to one another via at least one electrical or electronic component.

13. The terminal arrangement according to claim 12, wherein the at least one component comprises a resistor, an inductor, a capacitor, a diode or a varistor.

14. The terminal arrangement according to claim 13, wherein the mating contact for the terminal contact section of the inner shield and the mating contact for the terminal contact section of the outer shield are formed on mutually different printed circuit board layers of the printed circuit board.

15. A method for producing a terminal arrangement, comprising the steps of:
producing or selecting a printed circuit board with mating contacts, and
electrically contacting the terminal contact sections of a plug connector part according to claim 1 with the mating contacts of the printed circuit board,
wherein the printed circuit board is produced in such manner that the mating contacts for the terminal contact portion of the inner shield and for the terminal contact portion of the outer shield are optionally electrically separated from one another or electrically connected to one another.
